(19) United States
(12) Patent Application Publication
(10) Pub. No.: US 2025/0055714 A1
(43) Pub. Date: Feb. 13, 2025

(54) SELF-CALIBRATION METHOD AND SELF-CALIBRATION OF MEASURING DEVICES

(71) Applicant: Siemens Energy Global GmbH & Co. KG, Erlangen (DE)

(72) Inventor: Andreas Rathgeb, Poxdorf (DE)

(73) Assignee: Siemens Energy Global GmbH & Co. KG, Munich, Bayern (DE)

(21) Appl. No.: 18/720,648

(22) PCT Filed: Nov. 30, 2022
(86) PCT No.: PCT/EP2022/083792

§ 371 Date: Jun. 16, 2024

(30) Foreign Application Priority Data
Dec. 21, 2021 (DE) 10 2021 214 808.5

(51) Int. Cl. H04L 9/00; G01D 18/00

(52) U.S. Cl. CPC H04L 9/50; G01D 18/00

(57) ABSTRACT

A secure method for self-(re)calibration or self-calibration of devices, more particularly measuring devices, by the operator, wherein a digitized process flow in a data chain (DLT), more particularly blockchain established and secured using distributed ledge technology, is used. The method includes a digitized process sequence set up in a data chain (DLT), a device is registered with its implemented measuring device properties, an inspection authority gains access to the measurement information from the device, the inspection authority establishes an operative connection between the device and a working standard, the determined measurement data for the working standard are read out in encrypted form and are transmitted to the inspection authority in encrypted form, in the event of successful calibration or gaging of the device, the inspection authority stores this result in the data chain.

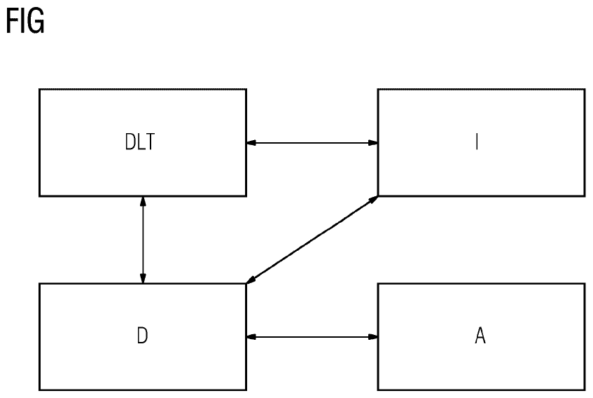

### CROSS REFERENCE TO RELATED APPLICATIONS

This application is the US National Stage of International Application No. PCT/EP2022/083792 filed 30 Nov. 2022, and claims the benefit thereof, which is incorporated by reference herein in its entirety. The International Application claims the benefit of German Application No. DE 10 2021 214 808.5 filed 21 Dec. 2021.

### FIELD OF INVENTION

The invention relates to a trustworthy method for the self-(re)gaging or self-calibration of devices, in particular measuring devices, in the hands of the operator.

### BACKGROUND OF INVENTION

The gaging process for a measuring device is carried out according to the statutory gaging regulations as follows.

Manufacturer tasks:

The design of the measuring device must be gageable. This is ensured by the manufacturer by requesting design approval, for example, from the German National Metrology Institute (Physikalisch-Technische Bundesanstalt, PTB). The PTB is an officially recognized inspection body and operates according to clear conformity assessment methods.

In this case, accuracy classes and measurement stability and operational error limits are defined. In addition, the devices must already be protected from corruption by the manufacturer.

The device instances which are manufactured according to the design type are generally gaged for a defined time ex works. This is expressed by the gaging label which documents the life, approval mark, inspection date and inspection body on the device.

The manufacturer is also obliged to ensure and maintain the gageability of the device by sampling devices on the market.

Operator tasks:

The measuring device operator is obliged to have a regaging carried out before the validity of the gaging expires and to document this. He must be able to demonstrate the validity of the gaging on demand at any time.

For this purpose
a gaging order is sent to the inspection body,
a date is agreed,
the gaging prerequisites for the device are created (stop operation, removal, and so on),
access is approved and prepared for the gaging personnel. Under certain circumstances, these are hazardous areas which are accessible only under special conditions (training, demarcation),
the regaging is carried out,
the device is installed again,
the verification is marked on the device,
the process is documented and invoiced.

If unsuccessful, the procedure must be repeated if necessary.

Inspection body tasks:

Inspection bodies are legally recognized implementation bodies having the expert competence and the personnel for carrying out gaging processes. Inspection bodies are obliged to monitor use and offer regaging. For the regaging, inspection bodies use so-called working standards which are derived from a reference measurement object, the normal, and should be used in situ.

Recurring inspections may have a different amount of effort and costs depending on the measuring device and inspection scope/inspection value. Regaging may cost, for example, €55-245 (for instance for balances) plus fees. The inspection mark and the paperwork are included depending on the inspection object.

A regaging of measuring devices by the operator himself is trustworthy only to a limited extent.

### SUMMARY OF INVENTION

The invention is based on the problem of providing a method by way of which an operator himself can calibrate or gage a device, in particular a measuring device, in situ in a manner that meets the requirements of a gaging.

The problem is solved by a method having the features of the independent claim.

The problem is solved with little effort and without losing trust in the process and the result by using distributed ledger technology (DLT). For this purpose, appropriate measures which achieve the desired result by way of a specific sequence are required from the involved parties.

According to the invention, measuring devices are calibrated using a trustworthy digital process, in particular in an automated manner.

Operator:

The currently still manual complicated process is replaced with efficient digital processes and accelerated. The regaging processes can be flexibly planned and carried out. Travel costs are minimized by pure transport costs (working standards).

As a result of the transparent documentation of the gaging via the Internet, it is possible to establish additional trust in the customers (automobile drivers, food buyers, electricity reading).

Manufacturer:

The devices become more attractive to the customers since they can be used better.

Quality assurance for the manufacturer is simplified by the complete recording. An evaluation of mass data (behavior of the devices during the regaging process) can be statistically used to record the quality.

The ability to provide encrypted measurement information can be used for further services which become necessary, for example, for invoicing purposes (automated pay-per-use).

Inspection body:

The effort and costs of the service fall.

This may be a unique selling point for inspection bodies which use this concept early.

New user: any desired contractual partners

The described digitized process can be comparably used for use in areas that are not liable to gaging. In this case, the measuring device properties implemented by the manufacturer are used by the contractual parties themselves.

The function can also be used here in devices without design type inspection and with mutually established working standards since only the accuracy guaranteed by the manufacturer is assessed as sufficient here.

The initial gaging provided by the manufacturer can also be implemented here by the contractual parties.

In this application, the manufacturer himself and/or the contractual parties can therefore agree on and maintain a calibration according to the process described above without an inspection body. In this case, DLT, as a trustworthy technology, is a solid and comprehensible basis for amicably resolving a dispute if necessary.

This manufacturer-based recalibration service now makes it possible for the manufacturer to offer permanently high-quality and therefore more sustained use of the devices, which provides increased reliability for the end customer.

Advantageous developments of the invention are specified in the subclaims.

### BRIEF DESCRIPTION OF THE DRAWINGS

The invention is explained in more detail below as an exemplary embodiment in a scope required for understanding on the basis of a figure, in which:

FIG shows a schematic illustration of the elements implementing the method according to the invention.

### DETAILED DESCRIPTION OF INVENTION

The problem is solved with little effort and without losing trust in the process and the result by using distributed ledger technology (DLT). For this purpose, appropriate measures which achieve the desired result by way of a specific sequence are required from the involved parties.

Note: DLT, often also described by the keyword “blockchain”, provides, inter alia, non-corruptible storage and non-corruptible automatisms using a special infrastructure.

According to the invention, the measures include the non-corruptibly digitally capturable features of the real devices, and a process sequence that is protected by means of a digitized data chain (DLT), including DLT-protected data storage.

By capturing specific data:
manufacturer, device type, design type approval, hardware version and software version,
device instance, batch, . . .
operator in the period xy,
intended purpose,
inspection body,
gaging date, duration, inspection,
working standard instance (planned, used)
. . .

By way of a digitized sequence:

The construction type, certificate and instance of the gageable measuring device G are captured when with the manufacturer and are registered (DLT) at the latest upon delivery, including the gaging data (inspection date, validity period). In addition, the gageable measuring device has an ability to output gaging-relevant information for each measurement in encrypted form.

The operator purchases the measuring device and registers use (DLT) at the latest before expiry of the validity period. Before expiry, the operator requests regaging from an inspection body I and authorizes the inspection body to access the data.

The inspection body initiates the inspection.

For this purpose, the inspection body selects one or more working standards A. The working standards have a particular property: they are provided with machine-readable data which enable, inter alia, the encrypted identification and separate, unencrypted identification of the working standard.

The working standards are sent to the operator, if necessary in a sealed manner, in a suitable form of transport.

Sensitive working standards might possibly contain active monitoring functions which ensure integrity. The working standards can be sent without or only with an encrypted indication of the measurement variable in order to be able to (stochastically) carry out calibrations or regaging processes even with odd, unpredictable measurement variables.

Depending on the measurement variable, the working standards can be equipped with additional intelligence which ensures correct use.

Example: the regaging of a fuel pump is ensured by way of a test container as the working standard that can detect the connection to the fuel pump to be gaged. The container can communicate with the fuel pump and can itself trigger the signal for filling. The container can detect the test medium (density). The container can detect the temperature and pressure. The data can be read out in encrypted form by the operator and can be integrated in the plausibility check.

It is therefore possible to ensure the correct use of the working standard in the regaging process with the measuring device. The individual solution is dependent on the measurement variable and the devices.

The inspection body additionally creates an (individual) regaging sequence rule using the individual working standards. The sequence is such that it can be carried out online by means of a suitable (mobile) auxiliary device belonging to the operator (smartphone, tablet, web-based). This rule is part of the DLT data capture and an accompanying check for plausibility and correctness (error tolerance).

The operator ensures the necessary boundary conditions. The operator registers for the inspection process and starts the latter. The operator carries out the inspection steps instead of an employee of the inspection body. In this case, the operator captures the necessary and requested data. For each measuring process, the gageable measuring device transmits the encrypted regaging information which can be read, for example, by means of a QR tag and a smartphone or by means of character strings on the measuring device. The data are stored (DLT) and, if possible, are evaluated during the inspection process. The operator can produce a printout of the certificate and can attach it to the device. The operator returns the working standards which can receive a new encrypted identification from the inspection body for the next process.

If successful, the inspection body issues the certificate online. The result is stored (DLT). The operator gains access to these data. The operator can publicly release these data, so that customers can inspect them if necessary (balance for a shop counter, fuel pump for a gas station). The inspection body can start sampling using its own personnel, if necessary.

The manufacturer gains anonymized access to the data relating to his devices and can comply with his inspection order for optimization and quality assurance with the aid of the inspection bodies.

In addition to the regaging processes, further audits, for example summary audits, can be integrated in the calibration (total purchase of fuel from a gas station in relation to the quantity sold in total using gaged devices).

The present invention was explained in detail for illustrative purposes on the basis of specific exemplary embodiments. In this case, elements of the individual exemplary embodiments can also be combined with one another. Therefore, the invention should not be restricted to individual exemplary embodiments, but rather should only be restricted by the appended claims.

List of reference signs
A Working standard
D Device, measuring device
DLT Data chain, blockchain
I Inspection authority, manufacturer

1. A method for securely capturing data from devices, for purposes of calibration or gaging, comprising:
setting up a digitized process sequence in a data chain (DLT), which is created and protected using a distributed ledger technology,
registering a device (D) which is configured to output encrypted measurement information, with implemented measuring device properties of the device (D), in the data chain (DLT),
gaining access by an inspection authority (I) to the measurement information from the device (D),
establishing by the inspection authority (I) an operative connection, which is protected by the data chain (DLT), between the device (D) and a working standard (A), wherein the working standard is provided with identification data such that there is encrypted identification of the working standard and separate, unencrypted identification of the working standard,
reading out determined measurement data for the working standard (A) in encrypted form and transmitting to the inspection authority (I) in encrypted form,
in the event of successful calibration or gaging of the device, storing by the inspection authority (I) this result in the data chain (DLT).

2. The method as claimed in claim 1,
wherein the measuring device properties of a measuring device (D), comprise, from a random selection from the group: manufacturer, device type, construction type, design type approval, hardware version, software version, certificate, instance, gaging data, inspection date, validity period.

3. The method as claimed in claim 1,
wherein a gageable measuring device (D) is configured to output gaging-relevant information for each measurement in encrypted form.

4. The method as claimed in claim 1,
wherein the working standard (A) comprises an active monitoring function, on the basis of which integrity of the working standard is determined.

5. The method as claimed in claim 1,
wherein the working standard (A) receives a new encrypted identification for each process sequence from the inspection authority (I).

6. The method as claimed in claim 1,
wherein the device (D) outputs encrypted calibration information or encrypted regaging information for a measuring process.

7. The method as claimed in claim 6,
wherein the output encrypted calibration information or the encrypted regaging information is readable by QR tag and a smartphone on the device.

8. The method as claimed in claim 6,
wherein the output encrypted calibration information or the encrypted regaging information is readable by character strings on the device.

9. The method as claimed in claim 1,
wherein the device is calibrated or gaged in accordance with the determined measurement data for the working standard (A).

10. The method as claimed in claim 1,
wherein the devices comprise measuring devices.

11. The method as claimed in claim 1,
wherein the data chain (DLT) comprises a blockchain.

12. The method as claimed in claim 1,
wherein the device (D) is configured to output encrypted measurement information comprising data from measuring processes.

13. The method as claimed in claim 1,
wherein implemented measuring device properties of the device comprise identification features.

14. The method as claimed in claim 2,
wherein the measuring device (D) comprises a gageable measuring device.
